(19) United States
(12) Patent Application Publication
(10) Pub. No.: US 2008/0276622 A1
(43) Pub. Date: Nov. 13, 2008

(54) FUEL NOZZLE AND METHOD OF FABRICATING THE SAME

(76) Inventors: Thomas Edward Johnson, Greer, SC (US); Gregory Allen Boardman, Greer, SC (US); John Brandon MacMillan, Liberty, SC (US)

Correspondence Address: JOHN S. BEULICK (17851);ARMSTRONG TEASDALE LLP, ONE METROPOLITAN SQUARE, SUITE 2600, ST. LOUIS, MO, 63102-2740, US

(21) Appl. No.: 11/745,155

(22) Filed: May 7, 2007

(51) Int. Cl. F02C 7/22

(52) U.S. Cl. 60/800; 60/39.34

(57) ABSTRACT

A fuel nozzle includes a swirler assembly including a radially inner surface and a radially outer surface, a plurality of vanes coupled to the swirler assembly radially outer surface. Each vane includes a first sidewall and a second sidewall, the first and second sidewalls are joined at a leading edge and at an axially-spaced trailing edge, and a plurality of openings are formed through each respective vane. Each opening extends from the leading edge to the passage to define a flow passage that extends from the passage to the leading edge. A method for fabricating a fuel nozzle assembly is also described.

### BACKGROUND OF THE INVENTION

This invention relates generally to gas turbine engines and more particularly, to a fuel nozzle for a gas turbine engine and a method of fabricating the fuel nozzle.

At least some gas turbine engines ignite a fuel-air mixture in a combustor and generate a combustion gas stream that is channeled to a turbine via a hot gas path. Compressed air is channeled to the combustor by a compressor. Combustor assemblies typically have fuel nozzles that facilitate fuel and air delivery to a combustion region of the combustor. The turbine converts the thermal energy of the combustion gas stream to mechanical energy that rotates a turbine shaft. The output of the turbine may be used to power a machine, for example, an electric generator or a pump.

At least some known fuel nozzles include a swirler assembly and a plurality of vanes that are coupled to the swirler assembly. During fabrication, a cover is fabricated and attached to the fuel nozzle assembly such that the cover substantially circumscribes the vanes. As such, an interior surface of the cover and an exterior surface of the swirler assembly define a flowpath for receiving airflow channeled through the fuel nozzle.

During operation, fuel is typically channeled through a plurality of passages formed within the swirler assembly and through a plurality of openings defined in at least one side of each respective vane. Known vanes may also include a cavity that is formed within the vane using a casting or fabrication process such that fuel channeled through the swirler assembly passages is discharged into the vane cavity. Moreover, each vane includes a plurality of openings, commonly referred to as gas injection holes, that are introduced through a vane sidewall such that the openings are in a direction that is normal to a surface of the vane sidewall to enable fuel that is channeled into the vane cavity to be discharged from the vane cavity through a vane sidewall and mixed with an air stream that is traveling in a downstream direction.

To fabricate a known fuel nozzle, a core is typically utilized to form the cavity thus increasing the complexity of the casting process and also increasing the time required to cast the fuel nozzle. Additionally, the core within the known casting may shift within the vane resulting in varying wall thicknesses and varying length over diameter (L/D) ratios for the gas injection holes. This variation results in varying gas flow, which is detrimental for combustion operability.

Moreover, since the fuel nozzle vanes circumscribe the fuel nozzle body, the space between adjacent vanes is limited. As such, introducing holes through the side of a vane and into the vane cavity requires the use of a specially designed fixture that is configured to introduce holes at a right angle to the side surface of the vane. Moreover, the fixture must be sized to enable the it to be inserted between adjacent vanes to perform the operation. During fabrication, the fixture, which is required to fit in this tight space, may “roll” into the side of the vane causing the hole being introduced to have more variation in its diameter, which is also an undesirable feature with respect to combustion operability. As a result, fabricating known vanes to include the cavity and then introducing openings through the sides of the vanes into the cavity is a relatively difficult and time consuming procedure, thus increasing the overall cost of the fuel nozzle.

### BRIEF DESCRIPTION OF THE INVENTION

In one aspect, a method of fabricating a fuel nozzle assembly is provided. The method includes fabricating a swirler assembly that includes a radially inner surface, a radially outer surface, a first flow passage defined at least partially by the radially inner surface, and a plurality of substantially solid vanes extending radially outward from the swirler assembly radially outer surface, wherein each vane includes a first sidewall and a second sidewall that are connected together at a leading edge and at an axially-spaced trailing edge, and forming a plurality of openings in each respective vane, wherein each vane opening defines a second flow passage that extends from the vane leading edge to the first flow passage.

In another aspect, a fuel nozzle assembly is provided. The fuel nozzle assembly includes a swirler assembly including a radially inner surface and a radially outer surface, a plurality of vanes coupled to the swirler assembly radially outer surface. Each vane includes a first sidewall and a second sidewall, the first and second sidewalls are joined at a leading edge and at an axially-spaced trailing edge, and a plurality of openings are formed through each respective vane. Each opening extends from the leading edge to the passage to define a flow passage that extends from the passage to the leading edge.

In a further aspect, a gas turbine engine is provided. The engine includes a compressor and a combustor in flow communication with the compressor. The combustor includes a fuel nozzle assembly that includes a swirler assembly including a radially inner surface and a radially outer surface, a plurality of vanes coupled to the swirler assembly radially outer surface. Each vane includes a first sidewall and a second sidewall, the first and second sidewalls are joined at a leading edge and at an axially-spaced trailing edge, and a plurality of openings are formed through each respective vane. Each opening extends from the leading edge to the first flow passage to define a flow passage that extends from the passage to the leading edge.

### BRIEF DESCRIPTION OF THE DRAWINGS

FIG. 1 is a schematic view of an exemplary gas turbine engine;

FIG. 2 is a cross-sectional schematic view of an exemplary combustor that may be used with the gas turbine engine shown in FIG. 1;

FIG. 3 is a cross-sectional schematic view of an exemplary fuel nozzle assembly that may be used with the combustor shown in FIG. 2;

FIG. 4 is a perspective view of a portion of the fuel nozzle assembly shown in FIG. 3 with the outer shroud removed;

FIG. 5 is a cross-sectional view of an exemplary swirler vane that may be used with the fuel nozzle shown in FIGS. 3 and 4; and

FIG. 6 is a cross-sectional view of another exemplary swirler vane that may be used with the fuel nozzle shown in FIGS. 3 and 4.

### DETAILED DESCRIPTION OF THE INVENTION

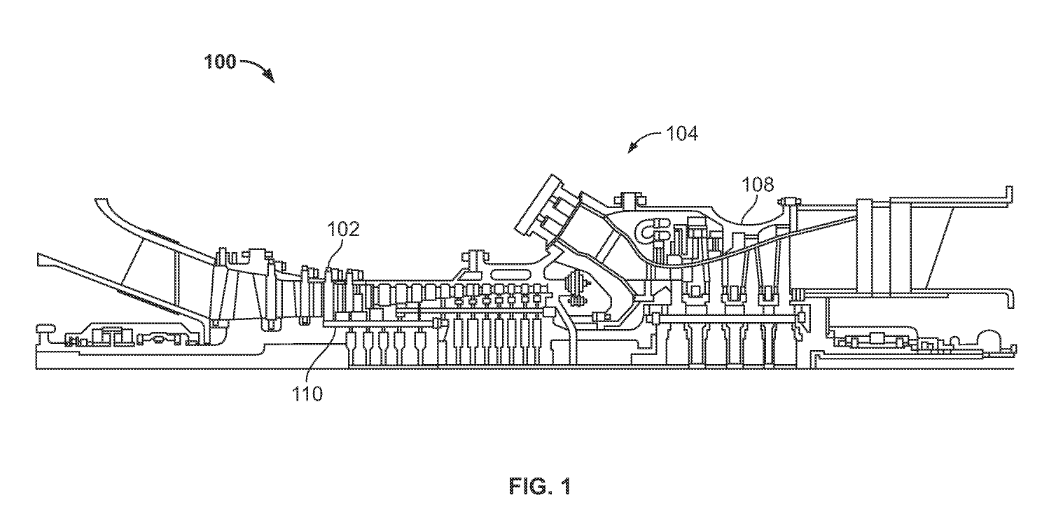

FIG. 1 is a schematic illustration of an exemplary gas turbine engine 100. Engine 100 includes a compressor 102 and a plurality of combustors 104. Engine 100 also includes a turbine 108 and a common compressor/turbine shaft 110 (sometimes referred to as the rotor 110).

In operation, air flows through compressor 102 and compressed air is supplied to combustors 104. Fuel is channeled to a combustion region, within combustors 104 wherein the fuel is mixed with the air and ignited. Combustion gases are generated and channeled to turbine 108 wherein gas stream thermal energy is converted to mechanical rotational energy. Turbine 108 is rotatably coupled to, and drives, shaft 110.

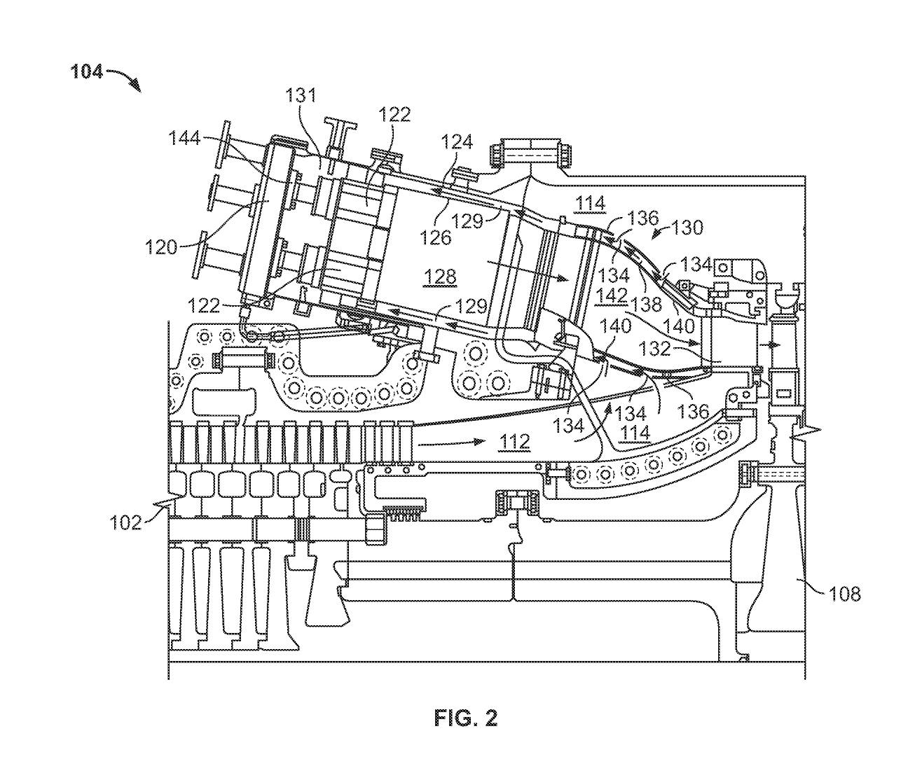

FIG. 2 is a cross-sectional schematic view of a combustor 104. Combustor assembly 104 is coupled in flow communication with turbine assembly 108 and with compressor assembly 102. Compressor assembly 102 includes a diffuser 112 and a compressor discharge plenum 114 that are coupled in flow communication to each other.

In the exemplary embodiment, combustor assembly 104 includes an end cover 120 that provides structural support to a plurality of fuel nozzles 122. End cover 120 is coupled to combustor casing 124 with retention hardware (not shown in FIG. 2). A combustor liner 126 is positioned within and is coupled to casing 124 such that liner 126 defines a combustion chamber 128. An annular combustion chamber cooling passage 129 extends between combustor casing 124 and combustor liner 126.

A transition portion or piece 130 is coupled to combustor chamber 128 to facilitate channeling combustion gases generated in chamber 128 towards turbine nozzle 132. In the exemplary embodiment, transition piece 130 includes a plurality of openings 134 formed in an outer wall 136. Piece 130 also includes an annular passage 138 defined between an inner wall 140 and outer wall 136. Inner wall 140 defines a guide cavity 142.

In operation, turbine assembly 108 drives compressor assembly 102 via shaft 110 (shown in FIG. 1). As compressor assembly 102 rotates, compressed air is discharged into diffuser 112 as the associated arrows illustrate. In the exemplary embodiment, the majority of air discharged from compressor assembly 102 is channeled through compressor discharge plenum 114 towards combustor assembly 104, and a smaller portion of compressed air may be channeled for use in cooling engine 100 components. More specifically, the pressurized compressed air within plenum 114 is channeled into transition piece 130 via outer wall openings 134 and into passage 138. Air is then channeled from transition piece annular passage 138 into combustion chamber cooling passage 129. Air is discharged from passage 129 and is channeled into fuel nozzles 122.

Fuel and air are mixed and ignited within combustion chamber 128. Casing 124 facilitates isolating combustion chamber 128 and its associated combustion processes from the outside environment, for example, surrounding turbine components. Combustion gases generated are channeled from chamber 128 through transition piece guide cavity 142 towards turbine nozzle 132. In the exemplary embodiment, fuel nozzle assembly 122 is coupled to end cover 120 via a fuel nozzle flange 144.

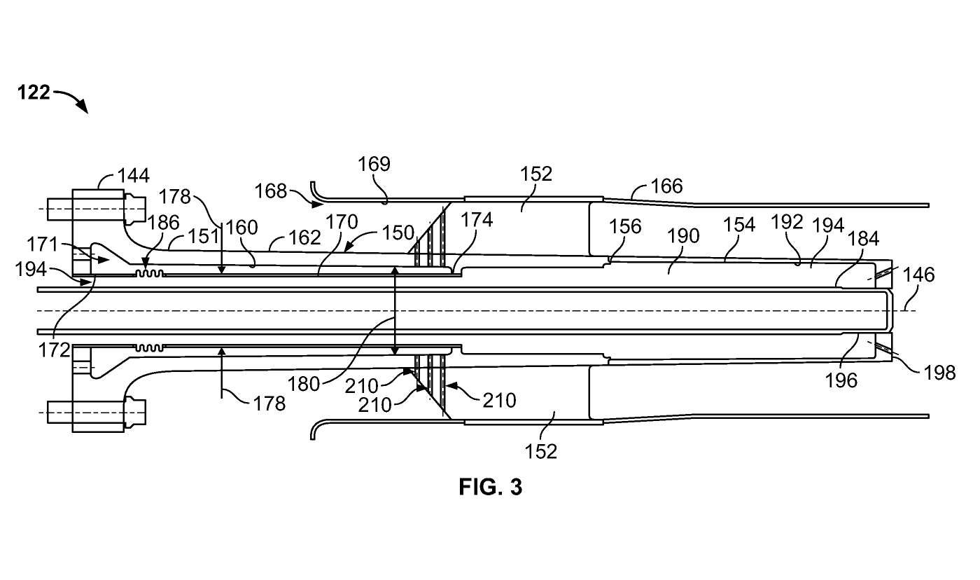

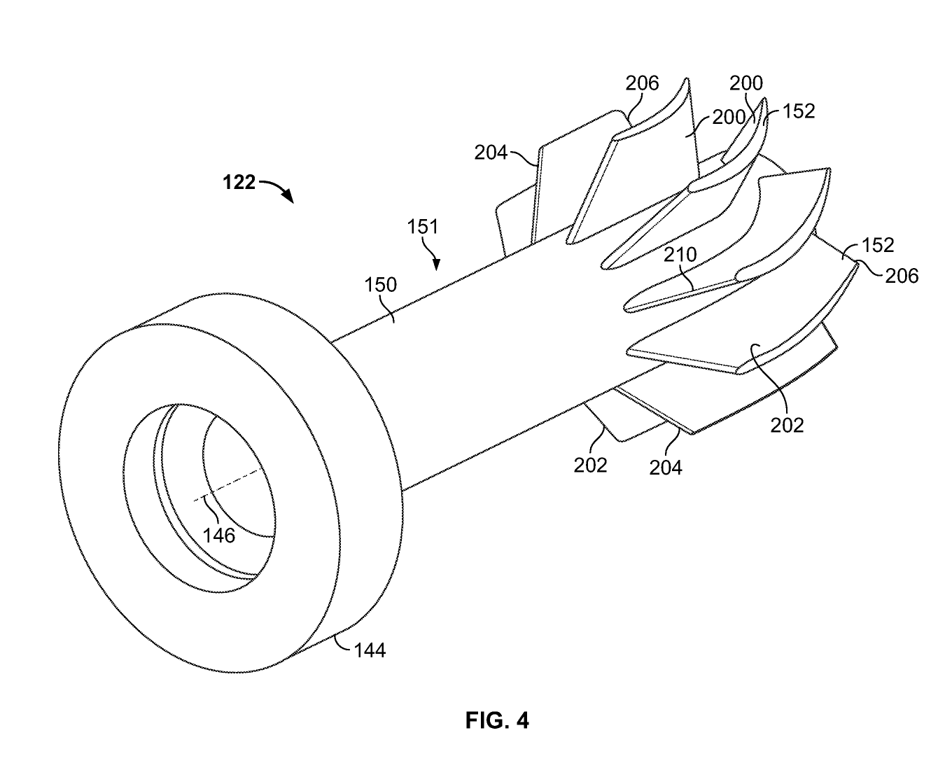

FIG. 3 is a cross-sectional view of fuel nozzle assembly 122. FIG. 4 is a perspective view of a portion of fuel nozzle assembly 122 shown in FIG. 3 with the shroud removed. In the exemplary embodiment, fuel nozzle assembly 122 has a centerline axis 146 and includes a swirler assembly 151 that includes a hub 150, a plurality of vanes 152 coupled to hub 150, and a center body tube 154 that is coupled to a downstream end 156 of hub 150. More specifically, hub 150 includes a radially inner surface 160 and a radially outer surface 162, and the plurality of vanes 152 extend radially outward from the swirler assembly radially outer surface 162. In the exemplary embodiment, hub 150, vanes 152, and flange 144 are cast or fabricated as a unitary component as shown in FIG. 4. Optionally, vanes 152 and flange 144 may be coupled to hub 150 using a welding or brazing procedure, for example. Fuel nozzle assembly 122 also includes a cover or shroud 166 that is coupled to and forms the outer periphery of the fuel nozzle assembly. Moreover, the shroud 166 also defines an air passage 168. Specifically, air passage 168 is defined between a radially inner surface 169 of shroud 166 and a radially outer surface 162 of hub 150.

Fuel nozzle assembly 122 also includes an annular premixing tube 170 that defines a premixing fuel passage 171 that will be discussed below. The premixing tube 170 is disposed within flange 144, hub 150, and centerbody tube 154. More specifically, premixing tube 170 has a first end 172 that is coupled to flange 144 and a second end 174 that terminates downstream from gas injection holes 210. Premixing tube 170 has a substantially circular cross-sectional profile and has an outer diameter 178 that is less an inner diameter 180 of both hub 150 and centerbody tube 154. In the exemplary embodiment, fuel nozzle assembly 122 may also include an atomized liquid fuel cartridge 196 that is disposed radially inwardly from premixing tube 170. As shown in FIG. 3, a radially outer surface 184 of liquid fuel cartridge 196 and a radially inner surface 192 of the centerbody tube 154 define another passage 194 that is utilized to channel fuel or air through the fuel nozzle assembly such that the fuel or air is discharged from a fuel nozzle tip 198. Optionally, fuel nozzle assembly 122 does not include liquid fuel cartridge 196. Premixing tube 170 may also include a bellows assembly 186 that facilitates compensating for varying rates of thermal expansion between hub 150 and premixing tube 170.

Referring again to FIG. 4, each vane 152 includes a first sidewall 200, and a second sidewall 202. The first and second sidewalls 200 and 202 are joined at a leading edge 204 and at an axially spaced trailing edge 206. Each vane also includes a plurality of openings 210, referred to herein as gas injection holes 210, that extend from the vane leading edge 204 to the premixing passage 171 such that fuel channeled through the premixing passage 171 is then channeled through each respective opening 210 and discharged from the leading edge 204 of each respective vane 152. As shown in FIG. 4, the trailing edge of each vane 152 is twisted such that it induces a swirl in the air stream 168 about the center body 154.

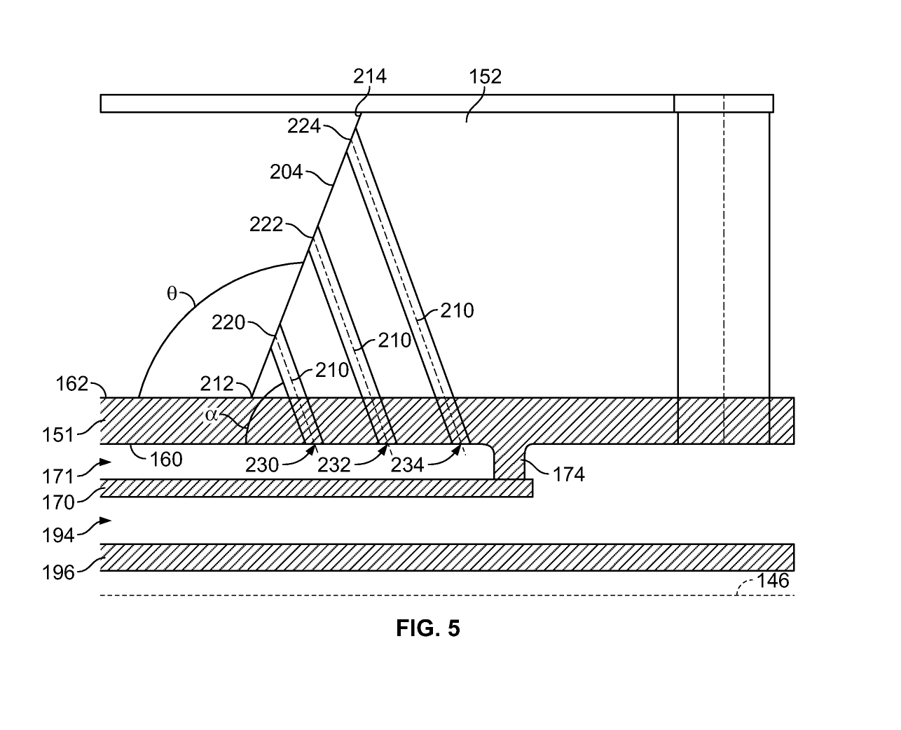

FIG. 5 is a cross-sectional view of an exemplary vane 152. In this embodiment, vane 152 has been machined or cast such that the leading edge 204 tapers from a vane root 212, that couples vane 152 to hub 150, to an axially downstream vane tip 214. In the exemplary embodiment, the vane leading edges 204 are fabricated or machined such that the leading edges 152 are formed at an angle theta (θ) that is between approximately 90 degrees and approximately 150 degrees with respect to hub 150. Moreover, fuel nozzle assembly 122 also includes a plurality of gas injection holes 210 that extend from vane leading edge 204, through vane 152, and through hub 150 such that, fuel channeled through premixing tube passage 171, through vane 152, is then discharged from vane 152 at the vane leading edge 204 via a respective gas injection hole.

In one exemplary embodiment, shown in FIG. 5, the exemplary vane 152 including three gas injection holes 210, it should be realized that each vane 152 may include a single gas injection hole 210, two gas injection holes 210, or n gas injection holes 210 wherein n≧3. For example, in this embodiment, vane 152 includes at least a first opening or gas injection hole 220, a second gas injection hole 222, and a third gas injection hole 224. In this embodiment, FIG. 5 shows the first gas injection hole 220 is substantially parallel to second gas injection hole 222, which is substantially parallel to third gas injection hole 224, However these holes need not be parallel. Moreover, each of first, second, and third gas injection holes 220, 222, and 224 are offset from the centerline axis 146 of fuel nozzle assembly 112 by an angle α. In one embodiment, α is between approximately 45 degrees and approximately 110 degrees, or beyond the normal orientation. In the exemplary embodiment, α is shown at approximately 60 degrees.

First opening or gas injection hole 220 is disposed upstream from second gas injection hole 222, which is disposed upstream from third gas injection hole 224. More specifically, first gas injection hole 220 has an inlet 230, second gas injection hole 222 has an inlet 232 that is disposed axially downstream from inlet 230, and third gas injection hole 224 has an inlet 234 that is disposed axially downstream from inlet 232. As shown in FIG. 5, each respective inlet allows fuel channeled through premixing tube passage 171 to be channeled through each respective inlet 230, 232 and 234, and into each respective gas injection hole 220, 222, and 224 and discharged at the leading edge 204 of vane 152.

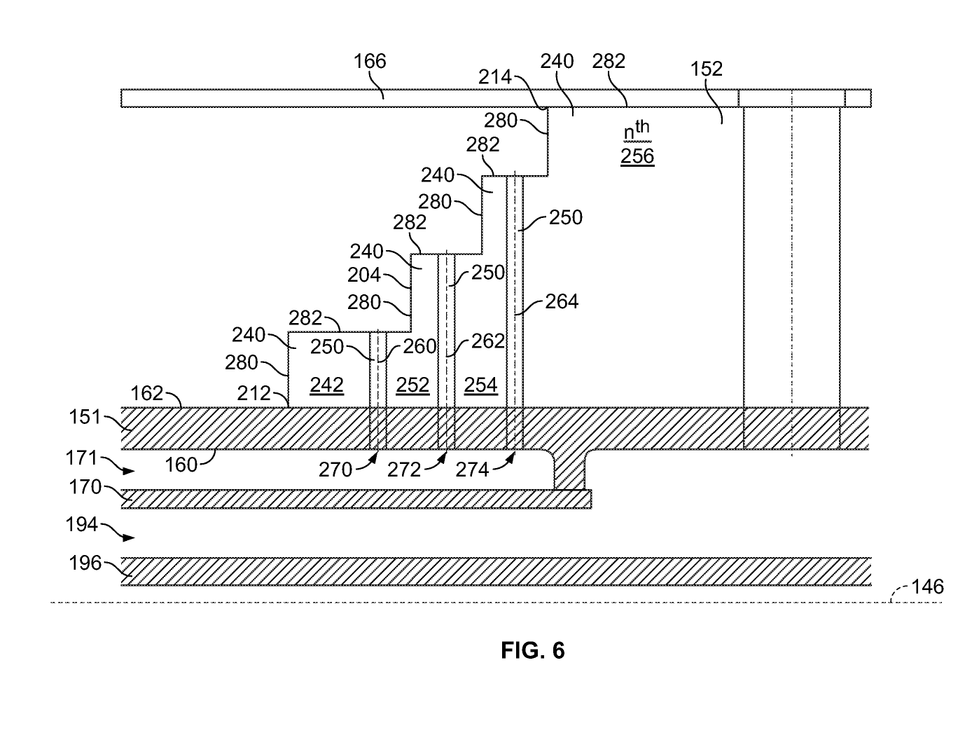

FIG. 6 is a cross-sectional view of another exemplary vane 152. In this embodiment, vane 152 has been machined or cast such that the leading edge 204 includes a plurality of steps 240 extending between the vane root 212 and the vane tip 214. In this embodiment, steps 240 are formed in ascending order from the vane root 212 to the vane tip 214 such that a first step 242 is formed proximate to vane root 212 and is disposed axially upstream from an nth step, which is formed proximate to, and as such forms vane tip 214.

Moreover, vane 152 also includes a plurality of gas injection holes 250 that extend from vane upper surface 282, through vane 152, and through hub 150 such that, fuel channeled through premixing tube passage 171 is channeled through vane 152, and discharged from vane 152 at the upper surface 282

Although FIG. 6 illustrates the exemplary vane 152 including four steps 240 and three gas injection holes 250, it should be realized that each vane 152 may include n steps 240 and n−1 gas injection holes 210 wherein n≧2. For example, in this embodiment, vane 152 includes at least first step 242, a second step 252, a third step 254, and a fourth step 256. Vane 152 also includes a first opening or gas injection hole 260 that extends through first step 242, a second gas injection hole 262 that extends through second step 252, and a third gas injection hole 264 that extends through third step 254. As shown in FIG. 6, first gas injection hole 260 is substantially parallel to second gas injection hole 262, which is substantially parallel to third gas injection hole 264. Moreover, each of first, second, and third gas injection holes 260, 262, and 264 are formed through a respective step such that each gas injection hole 260, 262, and 264 is approximately perpendicular to centerline axis 146 extending through fuel nozzle assembly 122.

Moreover, first opening or gas injection hole 260 is disposed upstream from second gas injection hole 262, which is disposed upstream from third gas injection hole 264. More specifically, first gas injection hole 260 has an inlet 270, second gas injection hole 262 has an inlet 272 that is disposed axially downstream from inlet 270, and third gas injection hole 264 has an inlet 274 that is disposed axially downstream from inlet 272. As shown in FIG. 6, each respective inlet allows fuel channeled through premixing tube passage 171 to be channeled through each respective opening 270, 272 and 274, and into each respective gas injection hole 260, 262, and 264 and discharged at the upper surface 28 of vane 152.

Each step 240 includes a leading edge surface 280 and an upper surface 282 that combine to form each individual step 240. In the exemplary embodiment, upper surface 282 is formed perpendicular to, or at a right angle from, leading edge surface 280. Optionally, upper surface 282 may be formed at an angle other than a right angle. As shown in FIG. 6, the combination of all of the leading edge surfaces 280 and the upper surfaces 282 form the vane leading edge 204.

During fabrication, flange 144, hub 150, and the plurality of vanes 152 are cast as a unitary structure to form swirler assembly 151. Moreover, as discussed above, the plurality of vanes 152, after casting are substantially solid. That is there are no voids or cavities intentionally cast with vanes 152 to accommodate fuel flow. The shroud 166 is coupled to the swirler assembly 151 such that the shroud 166 is then disposed around the vanes 152 as shown in the figures.

The plurality of gas injection holes 250 are introduced through the upper surface 282 of the vanes 152 as shown in either FIG. 5 or FIG. 6. The gas injection holes 250 will be introduced in the upper surface 282 prior to the shroud 166 being attached. Additionally, the gas injection holes 250 may be cast within vanes 152.

In operation, fuel nozzle assembly 122 receives compressed air from cooling passage 129 (shown in FIG. 2) via a plenum 131 (shown in FIG. 2) surrounding assembly 122. Most of the air used for combustion enters assembly 122 via passage 168 and is channeled to premixing components. A portion of high-pressure air entering the plenum 131 may also channeled into an air-atomized liquid fuel cartridge 196.

Fuel nozzle assembly 122 receives fuel from a fuel source (not shown in FIG. 3) via fuel supply passages 171 and 194. Fuel is channeled from premixed fuel supply passage 171 to the plurality of vanes 152 as discussed above. Additionally, air channeled into passage 168 is mixed with fuel, and the fuel/air mixture is swirled via turning vanes 152 and is channeled downstream and discharged from the fuel nozzle assembly 122. Similarly, fuel is channeled through fuel supply passage 194 and discharged through the fuel nozzle tip 198 during some modes of operation.

Described herein is an exemplary fuel nozzle assembly that may be used in a gas turbine engine. The fuel nozzle assembly includes a plurality of gas injection holes that inject fuel, such as natural gas, for example, into a cross-flowing air stream. For example, known vanes include feed holes that are oriented normal to the surface of the vane at a plurality of radial heights. These vane surfaces are substantially parallel to axial flow between adjacent vanes. However, the fuel nozzle described herein includes gas injection holes that are installed through the leading edge of the swirler vane. Moreover, in the preferred embodiment the leading edge of the vane is fabricated such that it is angled relative to the centerline of the fuel nozzle, as opposed to known vanes that have a leading edge that is vertical or 90 degrees offset from the centerline 146. Optionally, the fuel nozzle assembly may be fabricated by stepping the leading edge of the vane such that the gas injection holes are oriented radially inward.

During fabrication, the gas injection holes are then placed along the leading edge such that they emit the gas at the desired radial locations, which is required to attain the desired fuel air profile. Since the fuel nozzle described herein includes gas injection holes disposed at the vane leading edge, during operation, the fuel discharged from the gas injection holes is split into two streams about the vane, i.e. the suction and pressure sides, which aids in the circumferential mixing of the fuel and air. Additionally, the fuel is emitted from the vane over a given axial distance relative to the point where the mixture burns within the combustor. This axially distributed injection is considered a good feature with respect to lean premixed combustion systems because the combustion dynamic frequencies associated with the transport time constant of the fuel are now distributed. This results in any given natural system frequencies having less energy, resulting in lower combustion dynamics.

One advantage of the fuel nozzles described herein is that the vanes do not require a cavity that is formed during the casting process, thus reducing the cost of fabricating the fuel nozzle while providing good mixing characteristics. Moreover, the gas injection holes are introduced or cast radially inward, thus eliminating both the need for a casting core and the complex and time-consuming tooling. Moreover, the ease of drilling the gas injection holes allows for easier orifice hole size changes for “re-sizing” of fuel nozzles when operating conditions (fuel composition) changes. For example, smaller holes could be made larger by simply drilling out to form larger holes, and larger holes may be made smaller by using inserts.

As such, during operation, the axially distributed gas injection holes reduce the tendency for the combustion systems to have high dynamic instabilities by distributing the energy over a range of natural frequencies. Moreover, the gas injection hole location and diameter tolerances are easier to produce in an accurate manor relative to the baseline design, primarily due to the orientation of the holes.

Therefore, the fuel nozzle described herein facilitates significantly reducing the cost of the fuel nozzle, which is the largest cost in the combustion system, eliminating and/or reducing combustion dynamics, which is the number one problem with current lean, pre-mixed gas turbine combustion systems, and allows for a closer to even fuel nozzle split, resulting in lower emissions.

Also described herein is an exemplary method of fabricating a fuel nozzle assembly. The method includes fabricating a swirler assembly that includes a radially inner surface, a radially outer surface, a first flow passage defined at least partially by the radially inner surface, and a plurality of substantially solid vanes extending radially outward from the swirler assembly radially outer surface, wherein each vane includes a first sidewall and a second sidewall that are connected together at a leading edge and at an axially-spaced trailing edge, and forming a plurality of openings in each respective vane, wherein each vane opening defines a second flow passage that extends from the vane leading edge to the first flow passage.

While the invention has been described in terms of various specific embodiments, those skilled in the art will recognize that the invention can be practiced with modification within the spirit and scope of the claims.

What is claimed is:

1. A method for fabricating a fuel nozzle, said method comprising:
fabricating a swirler assembly that includes a radially inner surface, a radially outer surface, a first flow passage defined at least partially by the radially inner surface, and a plurality of substantially solid vanes extending radially outward from the swirler assembly radially outer surface, wherein each vane includes a first sidewall and a second sidewall that are connected together at a leading edge and at an axially-spaced trailing edge; and
forming a plurality of openings in each respective vane, wherein each vane opening defines a second flow passage that extends from the vane leading edge to the first flow passage.

2. A method in accordance with claim 1, further comprising:
fabricating each vane to include a root and a tip; and
tapering the leading edge from the root to the tip.

3. A method in accordance with claim 1, wherein said fabricating a swirler assembly further comprises fabricating a swirler assembly that includes a first opening and an nth opening, each of the first through the nth openings are offset from a centerline axis of the fuel nozzle by an angle α.

4. A method in accordance with claim 1, wherein said forming a plurality of openings further comprises introducing at least a first opening and a second opening through the vanes such that the first and second openings are approximately perpendicular to a centerline axis of the fuel nozzle.

5. A method in accordance with claim 4, further comprising introducing the second opening downstream from the first opening.

6. A method in accordance with claim 1, further comprising:
fabricating each vane to include a root and a tip; and
forming the leading edge to include a plurality of steps extending between the root and the tip, the steps formed in ascending order from the root to the tip such that a first step is formed proximate to the vane root is disposed upstream from an nth step that is formed proximate to the vane tip.

7. A fuel nozzle comprising:
a swirler assembly comprising a radially inner surface and a radially outer surface;
a plurality of vanes coupled to said swirler assembly radially outer surface, each said vane comprising a first sidewall and a second sidewall, said first and second sidewalls joined at a leading edge and at an axially-spaced trailing edge; and
a plurality of openings formed through each respective vane, each said opening extending from said leading edge to said passage to define a flow passage that extends from said passage to said leading edge.

8. A fuel nozzle in accordance with claim 7, wherein each said vane comprises a root and a tip, said leading edge is tapered from said root to said tip.

9. A fuel nozzle in accordance with claim 8, wherein said leading edge is offset from a centerline axis by an angle theta (θ) that is between approximately 90 degrees and approximately 150 degrees.

10. A fuel nozzle in accordance with claim 8, wherein said vane tip is disposed axially downstream from said vane root.

11. A fuel nozzle in accordance with claim 7 wherein said plurality of openings comprise at least a first opening and an nth opening, each of said first through said nth openings are offset from a centerline axis of said fuel nozzle by an angle α.

12. A fuel nozzle in accordance with claim 7, wherein said plurality of openings comprise at least a first opening and a second opening, said second opening is formed downstream from said first opening.

13. A fuel nozzle in accordance with claim 12 wherein said first opening is substantially parallel to said second opening.

14. A fuel nozzle in accordance with claim 7, wherein each said vane comprises a root and a tip, said leading edge comprises a plurality of steps extending between said root and said tip, said steps formed in ascending order from said root to said tip such that a first step formed proximate to said vane root is disposed upstream from an nth step formed proximate to said vane tip.

15. A fuel nozzle in accordance with claim 14, wherein said plurality of openings comprise at least a first opening and a second opening, each of said first and second openings are approximately perpendicular to a centerline axis of said fuel nozzle.

16. A gas turbine engine assembly comprising:
a compressor; and
a combustor in flow communication with said compressor, said combustor comprising at least one fuel nozzle assembly, said fuel nozzle assembly comprising:
a swirler assembly comprising a radially inner surface and a radially outer surface;
a plurality of vanes coupled to said swirler assembly radially outer surface, each said vane comprising a first sidewall and a second sidewall, said first and second sidewalls joined at a leading edge and at an axially-spaced trailing edge; and
a plurality of openings formed through each respective vane, each said opening extending from said leading edge to said passage to define a flow passage that extends from said passage to said leading edge.

17. A gas turbine engine assembly in accordance with claim 16, wherein each said vane comprises a root and a tip, said leading edge is tapered from said root to said tip.

18. A gas turbine engine assembly in accordance with claim 17, wherein said vane tip is disposed axially downstream from said vane root.

19. A gas turbine engine assembly in accordance with claim 16, wherein said plurality of openings comprise at least a first opening and a second opening, each of said first and second openings are offset from a centerline axis of said fuel nozzle by an angle α.

20. A gas turbine engine assembly in accordance with claim 16, wherein each said vane comprises a root and a tip, said leading edge comprises a plurality of steps extending between said root and said tip, said steps formed in ascending order from said root to said tip such that a first step formed proximate to said vane root is disposed upstream from an nth step formed proximate to said vane tip.

21. A gas turbine engine assembly in accordance with claim 20, wherein said plurality of openings comprise at least a first opening and a second opening, each of said first and second openings are approximately perpendicular to a centerline axis of said fuel nozzle.
